(19) United States
(12) Patent Application Publication
(10) Pub. No.: US 2023/0221680 A1
(43) Pub. Date: Jul. 13, 2023

(54) WATCH PROTECTIVE CASE WITH KNOB

(71) Applicant: Dongguan Yichuang Technology Co. , Ltd., Dongguan (CN)

(72) Inventor: Jun ZHANG, Xiangxiang (CN)

(73) Assignee: Dongguan Yichuang Technology Co. , Ltd., Dongguan (CN)

(21) Appl. No.: 17/846,066

(22) Filed: Jun. 22, 2022

(30) Foreign Application Priority Data
Jan. 13, 2022 (CN) 202220083548.7

(51) Int. Cl. G04B 37/00; G04B 37/22

(52) U.S. Cl. CPC G04B 37/0008; G04B 37/225

(57) ABSTRACT

The present invention relates to a watch protective case with a knob, including a soli rubber case body covering the outside of a watch in a cooperative manner and a hard rubber cover connected to the soft rubber case body in a cooperative manner on an upper end of the watch. A first soft rubber watchband and a second soft rubber watchband are respectively provided at two ends of the soft rubber case body, an adjustment hole is opened in a position on the soft rubber case body that corresponds to a watch button, and a knob adjustment component connected to the watch button in a cooperative and adhesive manner is provided within the adjustment hole. In addition, the adjustment hole is blocked by the knob adjustment component, which can effectively provide dust-proof and aesthetic effects.

### CROSS-REFERENCE TO RELATED APPLICATIONS

The application claims priority to Chinese patent application No. 202220083548.7, filed on Jan. 13, 2022, the entire contents of which are incorporated herein by reference.

### TECHNICAL FIELD

The present invention relates to the field of watch technologies, and in particular to a watch protective case with a knob.

### BACKGROUND

Watches are both decorative and convenient for checking the time. In daily life, electronic watches are popular. There are many smart electronic watches, and most of them have square structures. A protective case covers the outside of a watch to prevent the surface from being scratched or broken. The existing watch protective case is to wrap a watch by using full soft rubber or soft and hard rubber, so as to provide a protective effect of preventing the watch from being scratched and broken. However, after the watch is wrapped in the protective case, it is inconvenient to adjust the time and date. In addition, a through hole is provided in a position on the existing protective case that corresponds to an adjustment button of the watch, which easily leads to dust entering and a affects the appearance.

### SUMMARY

An objective of the present invention is to provide a watch protective case with a knob, which can protect the watch, and at the same time, it can be used for convenient adjustment and effectively provide dust-proof acid aesthetic effects.

In order to solve the above-mentioned technical problem, the present invention provides the following technical solution:

A watch protective case with a knob comprises a soft rubber case body covering the outside of a watch in a cooperative manner and a hard rubber cover connected to the soft rubber case body in a cooperative manner on an upper end of the watch, wherein a first soft rubber watchband and a second soft rubber watchband are respectively provided at two ends of the soft rubber case body, an adjustment hole is opened in a position on the soft rubber case body that corresponds to a watch button, and a knob adjustment component connected to the watch button in a cooperative and adhesive manner is provided within the adjustment tole.

Preferably, the knob adjustment component comprises an adjustment knob passing through the adjustment hole, and a soft adhesive patch is provided between the adjustment knob and the watch button.

Further preferably, the adjustment knob comprises an adjustment shaft inserted into the adjustment hole, a pad for clamping the soft adhesive patch with the watch button is provided at an inner end of the adjustment shaft, a knob wheel is provided at an outer end of the adjustment shaft, and the adjustment shaft, the pad and the knob wheel are integrally formed.

Further preferably, a buckle component is provided on the first soft rubber watchband, and a plurality of buckle holes that cooperate with the buckle component on tightness adjustments are opened on the second soft rubber watchband.

Further preferably, the buckle component comprises a buckle base passing through the first soft rubber watchband, the buckle base passes through a gasket, and a buckle head that cooperates with the buckle holes on buckling is connected to a top end of the buckle base.

The beneficial effects of the present invention are as follows: A watch protective case comprises a soft rubber case body covering the outside of a watch in a cooperative manner and a hard rubber cover connected to the soft rubber case body in a cooperative manner on an upper end of the watch, wherein a first soft rubber watchband and a second soft rubber watchband are respectively provided at two ends of the soft rubber case body, an adjustment hole is opened in a position on the soft rubber case body that corresponds to a watch button, and a knob adjustment component connected to the watch button in a cooperative and adhesive manner is provided within the adjustment hole. In the present invention, the knob adjustment component is connected within the adjustment hole of the soft rubber case body in a cooperative and adhesive manner, such that an adjustment is performed by the corresponding watch button through adhesiveness when the knob adjustment component is turned. In addition, the adjustment hole is blocked by the knob adjustment component, which can effectively provide dust-proof and aesthetic effects.

### BRIEF DESCRIPTION OF DRAWINGS

FIG. 1 is a structural schematic view of the present invention;

FIG. 2 is an exploded structural schematic view of the present invention; and

FIG. 3 is a partial enlarged view of FIG. 2 in the present invention.

### REFERENCE SIGNS

1. soft rubber case body, 2. hard rubber cover, 3. first soft rubber watchband, 4. second soft rubber watchband,

5. adjustment hole, 6. adjustment knob, 7. soft adhesive patch, 8. adjustment shaft, 9. pad,

10. knob wheel, 11. buckle hole, 12. buckle base, 13. gasket, 14. buckle head.

### DETAILED DESCRIPTION OF THE EMBODIMENTS

The present invention will be further described in detail below in conjunction with the accompanying drawings and embodiments.

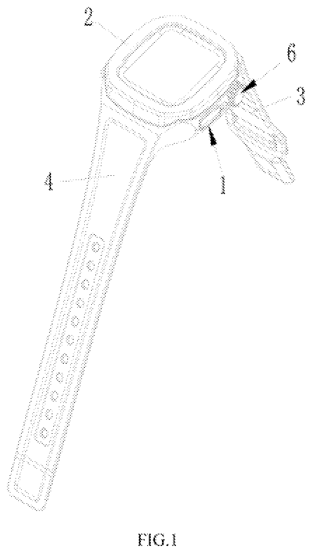

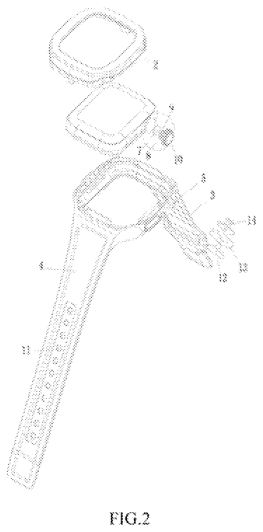

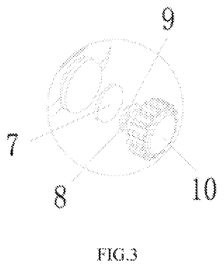

As shown in FIGS. 1 to 3, a watch protective case with a knob includes a soft rubber case body 1 covering the outside of a watch in a cooperative manner and a hard rubber cover 2 connected to the soft rubber case body 1 in a cooperative manner on an upper end of the watch. A first soft rubber watchband 3 and a second soft rubber watchband 4 are respectively provided at two ends of the soft rubber case body 1. An adjustment hole 5 is opened in a position on the soft rubber case body 1 that corresponds to a watch button. A knob adjustment component connected to the watch button in a cooperative and adhesive manner is provided within the adjustment hole 5. In the present invention, the knob adjustment component is connected within the adjustment hole 5 of the soft rubber case body 1 in a cooperative and adhesive manner, such that an adjustment is performed by the corresponding watch button through adhesiveness when the knob adjustment component is turned. In addition, the adjustment hole 5 is blocked by the knob adjustment component, which can effectively provide dust-proof and aesthetic effects.

In this embodiment, the knob adjustment component includes an adjustment knob 6 passing through the adjustment hole 5. A soft adhesive patch 7 is provided between the adjustment knob 6 and the watch button. The adjustment knob 6 includes an adjustment shaft 8 inserted into the adjustment hole 5. A pad 9 for clamping the soft adhesive patch 7 with the watch button is provided at an inner end of the adjustment shaft 8. A knob wheel 10 is provided at an outer end of the adjustment shaft 8. The adjustment shaft 8, the pad 9 and the knob wheel 10 are integrally formed. During use, the knob wheel 10 is pushed and pressed to rotate to enable the adjustment shaft 8 and the pad 9 to rotate together, thereby driving the soft adhesive patch 7 to adhere to the watch button to rotate, so as to adjust the time and date, etc.

In this embodiment, a buckle component is provided on the first soft rubber watchband 3, and a number of buckle holes 11 that cooperate with the buckle component on tightness adjustments are opened on the second soft rubber watchband 4. The buckle component includes a buckle base 12 passing through the first soft rubber watchband 3, the buckle base 12 passes through a gasket 13, and a buckle head 14 that cooperates with the buckle holes 11 on buckling is connected to a top end of the buckle base 12. The first soft rubber watchband 3, the second soft rubber watchband 4 and the soft rubber case body 1 are integrally formed. When the watch is worn, the buckle component of the first soft rubber watchband 3 is buckled in the buckle hole 11 of the second soft rubber watchband 4 in a cooperative manner in accordance with the thickness of the wrist. When the buckle hole 11 becomes larger after being buckled several times, the buckle head 14 at the top end of the buckle base 12 may be detached and replaced with a buckle head 14 whose size is suitable for the buckle hole 11.

Certainly, the foregoing descriptions are merely specific embodiments of the present invention, and are not intended to limit the scope of implementation of the present invention. Any equivalent changes or modifications made in accordance with the structures, features and principles described in the scope of the application patent of the present invention should be included in the scope of the application patent of the present invention.

What is claimed is:

1. A watch protective case with a knob, comprising a soft rubber case body covering the outside of a watch in a cooperative manner and a hard rubber cover connected to the soft rubber case body in a cooperative manner on an upper end of the watch, wherein a first soft rubber watchband and a second soft rubber watchband are respectively provided at two ends of the soft rubber case body, an adjustment hole is opened in a position on the soft rubber case body that corresponds to a watch button, and a knob adjustment component connected to the watch button in a cooperative and adhesive manner is provided within the adjustment hole.

2. The watch protective case with a knob of claim 1, wherein the knob adjustment component comprises an adjustment knob passing through the adjustment hole, and a soft adhesive patch is provided between the adjustment knob and the watch button.

3. The watch protective case with a knob of claim 2, wherein the adjustment knob comprises an adjustment shaft inserted into the adjustment hole, a pad for clamping the soft adhesive patch with the watch button is provided at an inner end of the adjustment shaft, a knob wheel is provided at: an outer end of the adjustment shaft, and the adjustment shaft, the pad and the knob wheel are integrally formed.

4. The watch protective case with a knob of claim 2, wherein a buckle component is provided on the first soft rubber watchband, and a plurality of buckle holes that cooperate with the buckle component on tightness adjustments are opened on the second soft rubber watchband.

5. The watch protective case with a knob of claim 4, wherein the buckle component comprises a buckle base passing through the first soft rubber watchband, the buckle base passes through a gasket, and a buckle head that cooperates with the buckle holes on buckling is connected to a top end of the buckle base.
